(19) United States
(12) Patent Application Publication
(10) Pub. No.: US 2023/0115077 A1
(43) Pub. Date: Apr. 13, 2023

(54) AEROSOL PROVISION DEVICE

(71) Applicant: Nicoventures Trading Limited, London (GB)

(72) Inventor: Shixiang CHEN, London (GB)

(21) Appl. No.: 17/759,773

(22) PCT Filed: Jan. 29, 2021
(86) PCT No.: PCT/GB2021/050206

§ 371 Date: Jul. 29, 2022

(30) Foreign Application Priority Data
Jan. 31, 2020 (GB) 2001342.1

(51) Int. Cl. G01F 23/263; A24F 40/51; A24F 40/40; A24F 40/10

(52) U.S. Cl. CPC G01F 23/266; A24F 40/51; A24F 40/40; A24F 40/10; G01F 23/268

(57) ABSTRACT

A method of controlling an electronic aerosol provision system including a capacitor formed by a first electrode, a second electrode and a dielectric between the first electrode and second electrode, a sensor for sensing an electrical characteristic of the capacitor, and a control unit, wherein at least a portion of the dielectric is provided in a cavity between the first electrode and the second electrode, the method including causing power to be supplied to the capacitor; identifying the onset of power to the capacitor to the capacitor as a first time; and measuring an electrical characteristic of the capacitor at a second time.

### PRIORITY CLAIM

The present application is a National Phase entry of PCT Application No. PCT/GB2021/050206, filed Jan. 29, 2021, which claims priority from Great Britain Application No. 2001342.1, filed Jan. 31, 2020, each of which is hereby fully incorporated herein by reference.

### TECHNICAL FIELD

The present disclosure relates to an electronic aerosol provision device and electronic aerosol provision system comprising the device.

### BACKGROUND

Electronic aerosol provision systems, such as e-cigarettes, which generate an aerosol for a user to inhale are well known in the art. Such systems are generally battery powered and contain an aerosol provision device comprising the battery and an aerosol provision component which may be engaged with the device so as to generate the aerosol. The aerosol can be generated in a variety of ways. For example, the aerosol may be generated by heating an aerosolizable material to form a vapor which subsequently condenses in passing air so to form a condensation aerosol. Alternatively, the aerosol might be generated by mechanical means, vibration etc. so that the aerosolizable material becomes dispersed in passing air so as to form an aerosol.

There is a desire in aerosol provision systems to monitor or otherwise determine the amount of aerosolizable material held in the aerosol provision component. For example, consumers may want an indication of how much usage is left before they have to replace or refill the aerosolizable material. Further, for certain aerosol provision systems the user may experience an undesirable taste after the aerosolizable material is sufficiently depleted such that an indication of a low level of aerosolizable material is desired. It would be desirable to provide an improved aerosol provision system that overcomes or alleviates the above issues.

### SUMMARY

In one aspect of the present disclosure there is provided a method of controlling an electronic aerosol provision system comprising a capacitor formed by a first electrode, a second electrode and a dielectric between the first electrode and second electrode, a sensor for sensing an electrical characteristic of the capacitor, and a control unit, wherein at least a portion of the dielectric is provided in a cavity between the first electrode and the second electrode, the method comprising: causing power to be supplied to the capacitor; identifying the onset of power to the capacitor to the capacitor as a first time; and measuring an electrical characteristic of the capacitor at a second time.

In another aspect of the present disclosure there is provided an electronic aerosol provision system comprising: a capacitor formed by a first electrode, a second electrode and a dielectric between the first electrode and second electrode, wherein at least a portion of the dielectric is provided in a cavity between the first electrode and the second electrode; a sensor for sensing an electrical characteristic of the capacitor; and a control unit configured to cause power to be supplied to the capacitor and to identify the onset of power to the capacitor as a first time, and determine from the sensor an electrical characteristic of the capacitor at a second time.

In a further aspect of the present disclosure there is an electronic aerosol provision means comprising: capacitor means formed by a first electrode, a second electrode and dielectric means between the first electrode and second electrode, wherein at least a portion of the dielectric means is provided in a cavity between the first electrode and the second electrode; sensor means for sensing an electrical characteristic of the capacitor means; and control means configured to cause power to be supplied to the capacitor means and to identify the onset of power to the capacitor as a first time, and determine from the sensor means an electrical characteristic of the capacitor means at a second time.

In a further aspect, there is provided a cartridge for use with an electronic aerosol provision device as described herein, wherein the cartridge comprises a capacitor formed by a first electrode, a second electrode and a dielectric between the first electrode and second electrode, wherein the dielectric comprises an aerosolizable material and/or air provided in a cavity between the first electrode and the second electrode, and wherein the cartridge is configured to attach to the electronic aerosol provision device.

These and other aspects as apparent from the following description form part of the present disclosure. It is expressly noted that a description of one aspect may be combined with one or more other aspects, and the description is not to be viewed as being a set of discrete paragraphs which cannot be combined with one another.

### BRIEF DESCRIPTION OF THE DRAWINGS

FIG. 1 is a schematic representation of a conventional aerosol provision device.

FIG. 2 is a schematic diagram of an exemplary aerosol provision device according to the present disclosure.

FIG. 3 is a cross-sectional view through an example container for containing an aerosolizable material, in accordance with the exemplary aerosol provision device of FIG. 2.

FIG. 4 is a cross-sectional view through an example container for containing an aerosolizable material, in accordance with the exemplary aerosol provision device of FIG. 2.

FIG. 5 is a cross-sectional view through an example container for containing an aerosolizable material, in accordance with the exemplary aerosol provision device of FIG. 2.

FIG. 6 is a cross-sectional view through an example container for containing an aerosolizable material, in accordance with the exemplary aerosol provision device of FIG. 2.

FIG. 7 is a schematic diagram of an exemplary sensor provided within an exemplary aerosol provision device according to the present disclosure.

FIG. 8 is a graph of capacitance against AC frequency measured for a container broadly in accordance with the example container of FIG. 3.

FIG. 9 is a graph of capacitance against AC frequency measured for a container broadly in accordance with the example container of FIG. 4.

FIG. 10 is a graph of capacitance against AC frequency measured for a container broadly in accordance with the example container of FIG. 6.

FIG. 11 is a graph of a capacitor voltage against time measured for a container broadly in accordance with the example container of FIG. 3.

FIG. 12 schematically represents a method of controlling an aspect of the electronic aerosol provision device in accordance with certain embodiments of the disclosure.

### DETAILED DESCRIPTION OF THE DRAWINGS

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to an aerosol provision system, such as an e-cigarette. Throughout the following description the term “e-cigarette” is sometimes used but this term may be used interchangeably with aerosol (vapor) provision system. Furthermore, an aerosol provision system may include systems which are intended to generate aerosols from liquid source materials, solid source materials and/or semi-solid source materials, e.g. gels. Certain embodiments of the disclosure are described herein in connection with some example e-cigarette configurations (e.g. in terms of a specific overall appearance and underlying vapor generation technology). However, it will be appreciated the same principles can equally be applied for aerosol delivery systems having different overall configurations (e.g. having a different overall appearance, structure and/or vapor generation technology).

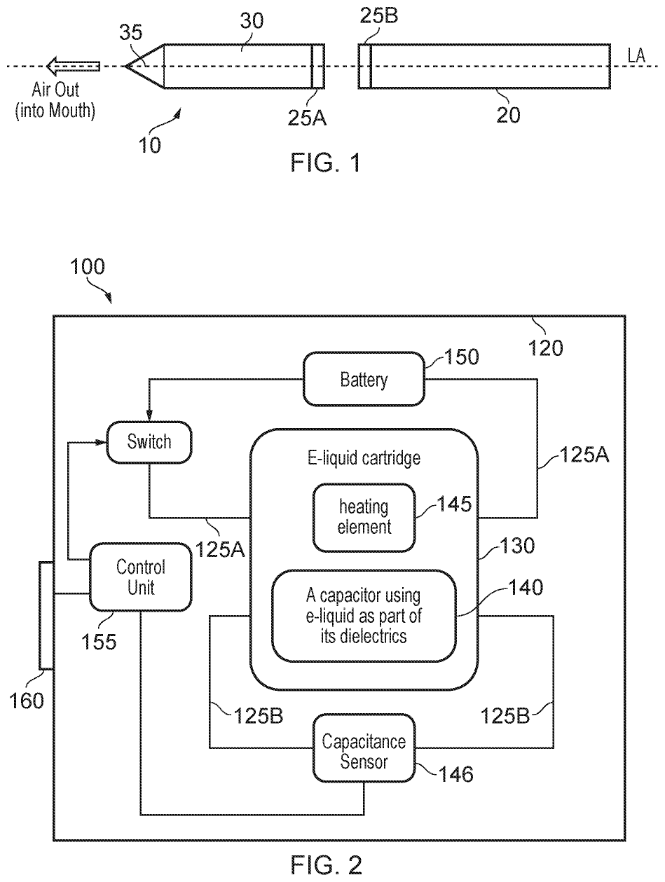

FIG. 1 is a schematic diagram of an exemplary aerosol/vapor provision system (not to scale). The exemplary e-cigarette 10 has a generally cylindrical shape, extending along a longitudinal axis indicated by dashed line LA, and comprising two main components, namely a body 20 (aerosol provision device) and a cartomizer 30. The cartomizer includes an internal chamber containing a reservoir of a source liquid comprising a liquid formulation from which an aerosol is to be generated, a heating element (which is an example of an aerosol generator), and a liquid transport element (in this example a wicking element) for transporting source liquid to the vicinity of the heating element. The heating element, a portion of the liquid transport element and a volume surrounding the heating element and the portion of the liquid transport element may be referred to as the aerosol generation region (i.e., the region in which an aerosol is generated).

The cartomizer 30 further includes a mouthpiece 35 having an opening through which a user may inhale the aerosol from the heating element. The source liquid may be of a conventional kind used in e-cigarettes, for example comprising 0 to 5% nicotine dissolved in a solvent comprising glycerol, water, and/or propylene glycol. The source liquid may also comprise flavorings. The reservoir for the source liquid may comprise a porous matrix or any other structure within a housing for retaining the source liquid until such time that it is required to be delivered to the aerosol generator/vaporizer. In some examples the reservoir may comprise a housing defining a chamber containing free liquid (i.e. there may not be a porous matrix).

As discussed further below, the body 20 includes a re-chargeable cell or battery to provide power for the e-cigarette 10 and a circuit board including control circuitry for generally controlling the e-cigarette. In active use, i.e. when the heating element receives power from the battery, as controlled by the control circuitry, the heating element vaporizes source liquid in the vicinity of the heating element to generate an aerosol. The aerosol is inhaled by a user through the opening in the mouthpiece. During user inhalation the aerosol is carried from the aerosol generation region to the mouthpiece opening along an air channel that connects between them.

In the exemplary system of FIG. 1, the body 20 and cartomizer 30 are detachable from one another by separating in a direction parallel to the longitudinal axis LA, as shown in FIG. 1, but are joined together when the device 10 is in use by a connection, indicated schematically in FIG. 1 as 25A and 25B, to provide mechanical and/or electrical connectivity between the body 20 and the cartomizer 30. The electrical connector on the body 20 that is used to connect to the cartomizer may also serve as a socket for connecting a charging device (not shown) when the body is detached from the cartomizer 30. The other end of the charging device can be plugged into an external power supply, for example a USB socket, to charge or to re-charge the cell/battery in the body 20 of the e-cigarette. In other implementations, a cable may be provided for direct connection between the electrical connector on the body and the external power supply and/or the device may be provided with a separate charging port, for example a port conforming to one of the USB formats.

The e-cigarette 10 is provided with one or more holes (not shown in FIG. 1) for use as an air inlet. These holes connect to an air passage (airflow path) running through the e-cigarette 10 to the mouthpiece 35. Typically the air path through such devices is relatively convoluted in that it has to pass various components and/or take multiple turns following entry into the e-cigarette. The air passage includes a region around the aerosol generation region and a section comprising an air channel connecting from the aerosol generation region to the opening in the mouthpiece.

When a user inhales through the mouthpiece 35, air is drawn into this air passage through the one or more air inlet holes, which are suitably located on the outside of the e-cigarette. This airflow (or the associated change in pressure) may be detected by an airflow sensor (not shown), in this case a pressure sensor, for detecting airflow in electronic cigarette 10 and outputting corresponding airflow detection signals to the control circuitry. The airflow sensor may operate in accordance with conventional techniques in terms of how it is arranged within the electronic cigarette to generate airflow detection signals indicating when there is a flow of air through the electronic cigarette (e.g. when a user inhales or blows on the mouthpiece).

When a user inhales (sucks/puffs) on the mouthpiece in use, the airflow passes through the air passage (airflow path) through the electronic cigarette and combines/mixes with the vapor in the region around the aerosol generation region to generate the aerosol. The resulting combination of airflow and aerosol continues along the airflow path connecting from the aerosol generation region to the mouthpiece for inhalation by a user. The cartomizer 30 may be detached from the body 20 and disposed of when the supply of source liquid is exhausted (and replaced with another cartomizer if so desired). Alternatively, the cartomizer may be refillable.

In accordance with some example embodiments of the present disclosure, whilst the operation of the aerosol provision system may function broadly in line with that described above for the exemplary devices of FIG. 1, e.g. activation of a heater element to vaporize a source material so as to entrain an aerosol in a passing airflow which is then inhaled, the aerosol provision systems of some example embodiments of the present disclosure may include additional or alternative functionality to the exemplary device described in FIG. 1. In this regard, in accordance with exemplary embodiments of the present disclosure, an electronic aerosol provision system comprising: a capacitor formed by a first electrode, a second electrode and a dielectric between the first electrode and second electrode, wherein at least a portion of the dielectric is provided in a cavity between the first electrode and the second electrode; a sensor for sensing an electrical characteristic of the capacitor; and a control unit configured to cause power to be supplied to the capacitor and to identify the onset of power to the capacitor as a first time, and determine from the sensor an electrical characteristic of the capacitor at a second time. An electronic aerosol provision system having a control unit configured in this way is operable to provide a more accurate mechanism of determining information about the aerosolizable material present in aerosol provision system, such as the amount of aerosolizable material present in the aerosol provision system. Monitoring an electrical characteristic of the capacitor, such as the voltage, whilst supplying power across the capacitor between a first time and a second time can be used to determine the characteristics of the capacitor, which subsequently can be used to infer information about the aerosolizable material.

In accordance with some example embodiments of the present disclosure an aerosolizable material may be provided in the form of a liquid comprising propylene glycol, vegetable glycerine and water. At room temperature, the relative permittivity or dielectric constant of water is approximately 80, propylene glycol is approximately 27, and vegetable glycerine is approximately 45. Hence, the relative permittivity or dielectric constant of a liquid consisting substantially of propylene glycol, vegetable glycerine and water is likely to be in the range of 30 to 60 depending on the liquid formula (it will be appreciated that if these are the only 3 ingredients, the relative permittivity can vary between approximately 27 (when the liquid is substantially all propylene glycol) and approximately 80 (when the liquid is substantially all water)). In comparison, the relative permittivity of air is about 1. Other liquids suitable for vaporization and inhalation comprising, at least in part, components other than propylene glycol, vegetable glycerine and water may have a relative permittivity in the range of 20 to 90 depending on the liquid formula.

Broadly speaking, the capacitance between two electrodes separated by a dielectric depends proportionally on the dielectric constant of the dielectric (i.e. its relative permittivity). The exact value of capacitance additionally depends on the configuration of the electrodes and their position relative to each other. Generally the capacitance depends on the distance between adjacent or opposing surfaces of the two electrodes. However, if the configuration of the electrodes is fixed (i.e. the electrodes are fixed in their respective places during manufacture), then any change in capacitance is primarily due to a change in the dielectric between the electrodes (e.g. when the aerosolizable material is vaporized and replaced by air).

The dielectric may comprise any of air, liquid, a barrier material (e.g. a housing or coating covering an electrode), a porous material (e.g. a foam) or any combination of the above. By barrier material it is meant a material which separates the liquid from an electrode of the capacitor. By porous material it is meant a material between the electrodes of the capacitor within which at least a portion of the liquid is held (at least temporarily). As the relative permittivity of the dielectric changes between the first and second electrodes, a sensor can be used to measure a quantity associated with the capacitance of the capacitor. Any change in capacitance is dependent on relative changes in the proportional amounts of air and liquid between the electrodes (the amount of barrier material and porous material, if present, is not expected to change during use) and therefore can be used to determine an amount of aerosolizable material between the two electrodes. Said determination may in some examples be a determination that there is less than an amount of aerosolizable material remaining (e.g. less than 10%) rather than a determination of the specific amount of aerosolizable material remaining (e.g. 50%). Furthermore, the determined amount may be an absolute amount of aerosolizable material (e.g. a volume or mass) or a relative amount of aerosolizable material (e.g. a percentage with respect to “full” and “empty” states).

FIG. 2 is a diagram of an exemplary aerosol provision system 100 according to one embodiment of the present disclosure.

With reference to FIG. 2, a capacitor 140 may be provided in a cartomizer 130, similar to cartomizer 130 described above. More generally, the capacitor 140 may be provided in a reservoir or storage component for holding an aerosolizable material (for example, the aerosolizable material may be a liquid). The cartomizer 130 additionally contains a heating element 145, such as the heating element described above in relation to FIG. 1. The cartomizer 130 further comprises a connection configured to provide mechanical and electrical connectivity between the body 120 (which may be similar to body 120 described in FIG. 1) and the cartomizer 130. The electrical connectivity includes providing electrical connectivity between the capacitor 140 of the cartomizer 130 and a sensor 146 contained within the body 120. Note that various components and details of the body 120, e.g. such as the housing, have been omitted from FIG. 2 for reasons of clarity.

As explained above with respect to the exemplary device of FIG. 1, the device 100 of some example embodiments of the present disclosure can be activated by any suitable means. Such suitable activation means include button activation, or activation via a sensor (touch sensor, airflow sensor, pressure sensor, thermistor etc.). By activation, it is meant that the aerosol generating component can be energized such that vapor is produced from the source material. In this regard, activation can be considered to be distinct from actuation, whereby the device 100 is brought from an essentially dormant or off state, to a state in which once or more functions can be performed on the device and/or the device can be placed into a mode which can be suitable for activation. Device 100 may also comprise a display 160 or screen for providing a visual indication to a user.

In this regard, device 100 generally comprises a power supply/source 150 (e.g. a battery) which supplies power to an aerosol generator (i.e. the heating element 145) of the aerosol generating component. It is noted that the connection between the aerosol generator and the power supply may be wired or wireless. For example, where the connection is a wired connection 125A, the connection is facilitated by electrical contacts provided on a surface of the cartomizer 130 and electrical contacts of the body 120 which are in contact with each other when the cartomizer 130 is attached to the body 120. Alternatively, it is possible for the connection between the power source and the aerosol generating component to be wireless in the sense that a drive coil (not shown) present in the body 120 and connected to the power source 150 could be energized such that a magnetic field is produced. The aerosol generator 145 could then comprise a susceptor which is penetrated by the magnetic field such that eddy currents are induced in the susceptor and it is heated.

It is noted that while in principle the connection between the capacitor 140 and the sensor 146 may be wired or wireless, in practice the connection is wired 125B to prevent loss of signal/accuracy and reduce the number of component parts and overall cost of the cartomizer 130. For example, where the connection is a wired connection 125B, the connection is facilitated by electrical contacts provided on a surface of the cartridge 130 and electrical contacts of the body 120 which are in contact with each other when the cartridge 130 is attached to the body 120.

In the context of the present disclosure, an aerosol provision system is a system that comprises an aerosol provision device 120 and a cartridge 130.

The aerosol provision device typically contains a power source, such as a battery 150, and control electronics (or control unit 155) which is configured to direct power to an aerosol generator following an actuation signal such that aerosol can be generated. In some embodiments, the aerosol provision device 120 and cartridge 130 are formed as a single component. In some embodiments, the aerosol provision device and cartridge 130 are separate components which can be engaged together so as to facilitate aerosol generation.

The aerosol provision system comprises an aerosol generator, such as a heater, etc. The aerosol generator can be located in either the aerosol provision device or the cartridge 130. In some embodiments, an aerosol generator can be located in both the aerosol provision device and the cartridge. Aerosol generator is a component capable of generating aerosol from an aerosolizable material. In some embodiments, the aerosol generator is a heater capable of interacting with the aerosolizable material so as to release one or more volatiles from the aerosolizable material to form an aerosol. In some embodiments, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

The cartridge 130 either comprises the aerosolizable material from which an aerosol can be produced, or contains an area for receipt of such an aerosolizable material. For example, the aerosol generating component can take the form of a “tank”, “cartomizer” or “pod” comprising an area for receipt of an aerosolizable material. The area for receipt of the aerosolizable material may be accessible to the user for replenishing depleted aerosolizable material. Alternatively, the area for receipt of such an aerosolizable material may not be accessible to the user without destruction of the cartridge.

In some embodiments, the cartridge 130 may not comprise the aerosol generator (contrary to the example shown in FIG. 2). In these embodiments, the aerosol generator is generally present on the device and, upon engagement of the cartridge and the aerosol provision device, the aerosol generator is brought into sufficient proximity with the aerosolizable material such that it can be transformed into an aerosol as appropriate.

Whilst not a critical aspect of embodiments of the present disclosure, a suitable cartomizer 130 will now be described in general, although it should be appreciated that other configurations of the cartomizer 130 (with or without the aerosol generator) may be employed in accordance with the principles of the present disclosure.

The cartomizer 130 includes an aerosol generator (e.g. heating element 145) arranged in an air passage extending along a generally longitudinal axis of the cartomizer 130. The aerosol generator may comprise a resistive heating element adjacent a wicking element or other liquid transport element (not shown in FIG. 2) which is arranged to transport source liquid from a reservoir of source liquid (not shown in FIG. 2) within the aerosol generating component to the vicinity of the heating element for heating. The reservoir of source liquid in this example is adjacent to the air passage and may be implemented, for example, by providing cotton or foam soaked in source liquid. Ends of the wicking element are in contact with the source liquid in the reservoir so that the liquid is drawn along the wicking element to locations adjacent the extent of the heating element. The general configuration of the wicking element and the heating element may follow conventional techniques. For example, in some implementations the wicking element and the heating element may comprise separate elements, e.g. a metal heating wire wound around/wrapped over a cylindrical wick, the wick, for instance, consisting of a bundle, thread or yarn of glass fibers. In other implementations, the functionality of the wicking element and the heating element may be provided by a single element. That is to say, the heating element itself may provide the wicking function. Thus, in various example implementations, the heating element/wicking element may comprise one or more of: a metal composite structure, such as porous sintered metal fiber media (Bekipor® ST) from Bekaert, a metal foam structure, e.g. of the kind available from Mitsubishi Materials; a multi-layer sintered metal wire mesh, or a folded single-layer metal wire mesh, such as from Bopp; a metal braid; or glass-fiber or carbon-fiber tissue entwined with metal wires. The “metal” may be any metallic material having an appropriate electric resistivity to be used in connection/combination with a battery. The resultant electric resistance of the heating element will typically be in the range 0.5-5 Ohm. Values below 0.5 Ohm could be used but could potentially overstress the battery. The “metal” could, for example, be a NiCr alloy (e.g. NiCr8020) or a FeCrAl alloy (e.g. “Kanthal”) or stainless steel (e.g. AISI 304 or AISI 316). In some example implementations of an aerosol provision component according to embodiments of the present disclosure, the heating element may itself provide the liquid transport function. For example, the heating element and the element providing the liquid transport function may sometimes be collectively referred to as an aerosol generator/aerosol generating member/vaporizer/atomizer/distiller.

Whereas the embodiments discussed above with reference to FIG. 2 have to some extent focused on devices having a liquid aerosolizable material to generate the inhalable medium, as already noted the same principles may be adopted for devices based on other aerosolizable materials, for example solid materials, such as plant derived materials, such as tobacco derivative materials, or other forms of aerosolizable material, such as gel, paste or foam based aerosolizable materials. Thus, the aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosolizable material may for example comprise from about 50 wt %, 60 wt % or 70 wt % of amorphous solid, to about 90 wt %, 95 wt % or 100 wt % of amorphous solid.

The aerosolizable material (which may also be referred to as aerosol generating material or aerosol precursor material) may in some embodiments comprise a vapor- or aerosol-generating agent or a humectant. Example such agents are glycerine, propylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. A formulation comprising one or more aerosol generating agent(s) may be called an active herein.

Furthermore, and as already noted, it will be appreciated the above-described approaches may be implemented in aerosol delivery systems, e.g. electronic smoking articles, having a different overall construction than that represented in FIG. 2. For example, the same principles may be adopted in an aerosol delivery system which does not comprise a two-part modular construction, but which instead comprises a single-part device, for example a disposable (i.e. non-rechargeable and non-refillable) device. Furthermore, in some implementations of a modular device, the arrangement of components may be different. For example, in some implementations the control unit may also comprise the vaporizer with a replaceable cartridge providing a source of aerosolizable material for the vaporizer to use to generate aerosol.

Furthermore still, in some examples the receptacle (flavor insert/pod) arranged in the airflow path through the device may be upstream of the vaporizer as opposed to downstream of the vaporizer.

As used herein, the terms “flavor” and “flavorant”, and related terms, refer to materials which, where local regulations permit, may be used to create a desired taste or aroma in a product for adult consumers. The materials may be imitation, synthetic or natural ingredients or blends thereof. The material may be in any suitable form, for example, oil, liquid, or powder.

As previously stated, broadly speaking, the capacitance between two electrodes separated by a dielectric depends upon the dielectric constant of the dielectric, the distance separating the two electrodes, and the overlapping area of the two electrodes. Hence a capacitance sensor can be used to measure the capacitance between the two electrodes to determine an amount of aerosolizable material between the two electrodes. The capacitance may be measured indirectly by measuring a parameter (or multiple parameters) dependent on the capacitance. Accordingly, a change in the capacitance can be observed due to the change in relative permittivity/dielectric constant.

In the example of FIG. 2, the device 100 includes a control unit 155 contained within the body 120. The control unit 155 is configured to control (e.g. use) the sensor 146 to measure a parameter of the capacitor 140 formed by the first and second electrodes. In some examples, the sensor 146 may be a separate component housed within the body 120 that is electrically connected to the control unit 155, for example through wiring. In other examples, not shown, the sensor 146 may be integrated into the control unit 155 and/or provided by components of the control unit 155.

In some examples, the control unit 155 causes the supply of a voltage (Vₛ) between the first and second electrode (for example, by using a switch to connect the capacitor 140 into an electronic circuit with the battery 150). The sensor 146 is (additionally) configured to measure a voltage across the capacitor 140 and to provide values of the voltage measurements to the control unit 155.

There is a time delay between the onset of the supply of power/voltage across the capacitor 140 (i.e. the start of the supply of power between the first and second electrode) and the capacitor 140 charging to a threshold voltage. This time delay is dependent at least on the capacitance of the capacitor 140 which, as previously stated, is dependent on the configuration of the two electrodes (e.g. dependent on their separation and their overlapping surface area) and the dielectric constant of the material between the two electrodes. As such, if the dielectric material between the two electrodes changes (e.g. the amount of aerosolizable material forming the dielectric material reduces and the amount of air forming the dielectric material increases) then the dielectric constant will change and as a result so will the capacitance of the capacitor 140 and the time delay. The time delay and/or the capacitance may be indicative of an amount of aerosolizable material in the cartomizer 130. It will be appreciated that using a threshold voltage is just one example of a suitable electrical characteristic of the capacitor which can be used to infer the capacitance of the capacitor 140. The skilled person will be aware that other electrical characteristics of the capacitor can be monitored with respect to time so as to provide an indicative amount of aerosolizable material in the cartomizer 130. For example, the capacitor charge, or the current being supplied to the capacitor 140 can be monitored. Thus, reference can in general be made to a threshold electrical characteristic, and more particularly to a threshold voltage or a threshold current or a threshold charge.

In some examples, the control unit 155 is configured to determine the time delay based on measurements from the sensor 146. In some of these examples, the control unit 155 is configured to compare the determined time delay to one or more values stored in memory. The control unit 155 may control an aspect of the device 100 based on the comparison between the determined time delay and the one or more values stored in memory. As such, in some examples the time delay is a comparison value (i.e. it is a value that can be compared to one or more thresholds). In some examples, to determine the time delay, the control unit 155 is configured to determine a value of the time delay (e.g. 25 μs). In some examples, to compare the determined time delay to one or more values the control unit 155 is configured to compare the determined time delay to one or more values in memory to determine a relationship with respect to those values. A relationship may be characterized as any of equal to, not equal to, less than, less than and equal to, greater than, and greater than and equal to (e.g. time delay 25 μs value in memory 20 μs, or time delay 25 μs>20 μs).

In some examples, to determine (e.g. calculate) the time delay, the control unit 155 is configured to determine a range of values which contains the value of the time delay (e.g. greater than 20 μs, or greater than 20 μs and less than 30 μs). In some of these examples, the control part 155 may be configured to actively compare the time delay to one or more values by monitoring time and determining if the target voltage was reached within a particular time window. For example, the control part 155 can be configured to determine if the target voltage (i.e. threshold voltage) is reached or exceeded within 15 μs (e.g. the control part 155 determines that the time delay is less than 15 μs). As such, in some examples the voltage measured is a comparison value (i.e. it is a value that can be compared to one or more thresholds). The control part 155 may further be configured to continue monitoring (e.g. to determine if the target is reached within 15 μs to 20 μs, or any subsequent window) or the control part may be configured to cease monitoring and determine that the time delay is greater than 15 μs. In some examples, there may be multiple time windows before the control part ceases to monitor. It will be appreciated that in some examples, the control part 155 may be configured to determine a value of the time delay (e.g. 25 μs) within a time window (e.g. between 0 μs and 40 μs) and to determine one or more ranges outside of this window within which the time delay is determined to be (e.g. greater than 40 μs).

In some examples, the control unit 155 is configured to determine a rate of change in capacitance based on measurements from the sensor 146. In some examples, the control unit 155 is configured to determine the rate of change in capacitance by measuring the voltage at least two known times. For example, when only two measurements are used, the rate of change can be calculated as the voltage (later time) minus the voltage (earlier time) divided by the later time minus the earlier time (i.e. dV/dt=(V₁−Vₑ)/(t₁−tₑ)). For simplicity tₑ (the earlier time) and/or Vₑ (the earlier voltage) may be set to zero.

In these examples, the control unit 155 is configured to compare the determined rate of change to one or more values stored in memory. As such, in some examples the rate of change is a comparison value (i.e. it is a value that can be compared to one or more thresholds). The control unit 155 may control an aspect of the device 100 based on the comparison between the determined rate of change and the one or more values stored in memory. In some examples, to compare the determined time delay to one or more values the control unit 155 is configured to compare the determined rate of change to one or more values in memory to determine a relationship with respect to those values. A relationship may be characterized as any of equal to, not equal to, less than, less than and equal to, greater than, and greater than and equal to (e.g. rate of change 0.2 V/μs value in memory 0.3V/μs, or rate of change 0.20 V/μs>0.15 V/μs).

It will be appreciated that the determination of the time delay or rate of change is dependent on the sensitivity of the sensor 146 and control unit 155 to time and voltage. As such the determination of time delay or rate of change is an approximation dependent on the errors inherent in the measurement by the sensor. For example, if the control unit 155 is able to sample the sensor 146 with a sampling rate of 10⁶ Hz then the time delay will be accurate to the nearest μs (alternatively the control unit could rely on a clock which measures time to a certain accuracy). Similarly, if the threshold voltage is 3.0V but the sensor 146 and/or control unit 155 are sensitive to the nearest 0.1V then the control unit 155 may determine the threshold has been reached by any voltage value between 2.95V and 3.05V. While more accurate components can be used to provide more accurate measurements, the cost and/or size of said components may limit their usage in the aerosol provision system 100 for practical and/or economic reasons.

In some examples, the control unit 155 is configured to determine (e.g. calculate) a capacitance of the capacitor 140 based on the time delay or the rate of change. In these examples, the control unit 155 is configured to compare the determined capacitance to one or more values stored in memory. The control unit 155 may control an aspect of the device 100 based on the comparison between the determined capacitance, which is based on the determined time delay or rate of change, and the one or more values stored in memory. It will be appreciated that the determination of capacitance is limited based on the format of the determined time delay or rate of change as either a value (e.g. 25 μs) or a range of values (e.g. greater than 20 μs). The determined capacitance will typically share the same format although it will be appreciated that a value (e.g. 25 μs) can be used to determine a range within which the capacitance is contained (e.g. greater than 15 pf). For simplicity, in some examples a range of values may be represented (in memory) by an average value within a range (for closed ranges) or by an arbitrary value within the range (for open and closed ranges).

In some examples, the control unit 155 is configured to determine an amount of aerosolizable material present in the dielectric based on the determined time delay or rate of change, or based on the capacitance which has previously been determined based on the determined time delay. In these examples, the control unit 155 is configured to by compare the determined amount of aerosolizable material to one or more values stored in memory. It will be appreciated that the determination of the amount of aerosolizable material is similarly limited based on the format of either the determined time delay or rate of change, or the determined capacitance, as either a value or a range of values. The determined amount will typically share the same format although it will be appreciated that a single value can be used to determine a range within which the amount falls (e.g. greater than 0.1 ml or greater than 5%).

In the context of the instant application the term “amount of aerosolizable material” should be interpreted as meaning either a relative amount of aerosolizable material or an absolute amount of aerosolizable material. As an example, a relative amount may be provided as a value between 0% (0.0) when the cartomizer is empty (e.g. contains no aerosolizable material) and 100% (1.0) when cartomizer is at full capacity. As an example an absolute amount of aerosolizable material may be provided as a value in grams or milliliters.

In some examples, the amount of aerosolizable material in the dielectric may be equivalent to the amount of aerosolizable material in the cartridge 130 (e.g. the first and second electrodes of the capacitor substantially surround all of the aerosolizable material in the cartridge). In some examples, the amount of aerosolizable material in the dielectric may be proportional to the amount of aerosolizable material in the cartridge 130 (e.g. the first and second electrodes of the capacitor are arranged or configured to surround an amount of aerosolizable material which is substantially proportional to the amount of aerosolizable material in the cartridge). In some examples, the aerosolizable material in the dielectric may be in communication with the aerosolizable material in the cartomizer 130 such that a change in relation to a threshold (e.g. from an amount above a threshold to an amount below a threshold, or vice-versa) in the amount of aerosolizable material in the cartomizer 130 causes an change in the aerosolizable material in the dielectric.

The memory may be a memory of the control unit 155 or a memory accessible by the control unit 155. In some examples, the values for comparison (i.e. the one or more values for comparing with any of time delay, rate of change, capacitance and amount of aerosolizable material) in memory are pre-determined values. Said pre-determined values may be empirically pre-determined based on calibration experiments. In some examples, said pre-determined values may be stored on the device 100 at manufacture or may be provided to the device 100 with a software update. In some examples, the pre-determined values may be selected from a plurality of stored pre-determined values in response to a determination of cartomizer 130 and/or aerosolizable material type. In some examples the plurality of stored pre-determined values may be stored in a separate device such as a user's smart phone or a server; the control unit 155 configured to request a particular stored pre-determined value and/or to send data indicative of the cartomizer 130 and/or aerosolizable material type; and the control unit 155 configured to receive the required pre-determined data. Communications between the control unit 155 and a separate device may be facilitated by any conventional wired or wireless communications mechanisms electronically connected to the control unit 155 (e.g. communications may be via a USB port, or via a Bluetooth or WiFi transceiver). In some examples, the memory may be a memory of the cartomizer 130 and the control part 155 may be configured to read the memory of the cartomizer 130 to obtain one or more pre-determined values. Said pre-determined values may be programmed or otherwise written to the memory of the cartomizer 130 during manufacture.

In other examples, the control unit may be configured to generate or measure the values for comparison (i.e. the one or more values for comparing with any of time delay, rate of change, capacitance and amount of aerosolizable material). For example, the control unit 155 may determine a first time delay or first rate of change based on a first set of measurements (e.g. time at start of voltage onset and time at which the voltage target is achieved) and may compare a second, subsequently determined time delay or rate of change to the first determined time delay or rate of change, respectively. As such the control unit 155 is configured to store the value for comparison in memory to allow comparison with the second determined time delay at a later time. It will be appreciated that in other examples, the control unit 155 is configured to determine and store a value of a first determined capacitance and/or a value of an amount of aerosolizable material (instead of or in addition to a value of time delay or rate of change) for subsequent use in comparisons. In some examples, the value stored may be a relative value of a first determined value for comparison with a second determined value. For example a value stored may be any of 50%, 60%, 70%, 80%, 90%, 110%, 120%, 130%, 140%, and 150% of a determined value. Said relative values for comparison may provide threshold values.

In some examples, the first value (e.g. of time delay or rate of change) may be generated or measured for each new cartomizer, the first value being retained throughout the use of that cartomizer. In some examples, the control part 155 may be configured to determine a new cartomizer has been attached (e.g. based on a user action or on an ID associated with the cartomizer which is readable by the control part 155). In some examples, the first value may be generated or measured for each usage session (e.g. upon start-up of the device 100 or after a prolonged period without usage), the first value being retained throughout that usage session or until the next usage session. In some examples the first value may be written to a memory of the device 100. Additionally, if an ID of the cartomizer is known, then the first value may be associated with the ID of the cartomizer which will enable the cartomizer to be interchanged with other cartomizers without loss of information. In some examples where the cartomizer comprises a memory, the first value may be written to a memory of the cartomizer 130. Furthermore, after each usage a second value may be written to the memory of the cartomizer either in addition to or in place of the first value. As such if the same cartomizer is used with a different device, the different device may be able to determine that the cartomizer has previously been used and whether the cartomizer is still usable (e.g. whether the cartomizer is empty or not).

As previously stated, the control unit 155 is configured to control an aspect of the device 100 based on the determined time delay or rate of change either directly or indirectly based on a capacitance or amount of aerosolizable material derived from the value of time delay or rate of change. Whilst not exhaustive aspects of the device to be controlled include at least an aerosol generator (e.g. heating element 145), a communications interface (e.g. a wired or wireless interface), a notification unit such as a light emitting unit (e.g. one or more LEDs), a display 160, a speaker or a haptic feedback module to provide an output to a user (e.g. notifying them of a characteristic of the capacitor). In the example of a communications interface, the output is via a separate device in communication with the device 100. In some examples, the aspect controlled is the control unit 155 itself (for example, the control unit 155 may perform further calculations based on the determination). By control an aspect, it is meant that the control unit provides signals or instructions which affect the operation of at least the aspect.

In some examples, in response to determining a time delay or rate of change the control unit is configured to control the control unit (i.e. itself) to determine a capacitance and/or an amount of aerosolizable material. In some examples, in response to determining a time delay or rate of change the control unit is configured to control the display to display to the user the value of the determined timed delay, rate of change, capacitance and/or amount of aerosolizable material, or an image capable of indicating said values or associated with said values (for example, text stating “cartomizer low”). In some examples, in response to the result of a comparison of the determined timed delay, rate of change, capacitance and/or amount of aerosolizable material to one or more values, the control unit is configured to control a notification unit to provide a notification to a user (e.g. a haptic rumble or a sound). The notification may provide an indication to the user that the cartomizer 130 is running out of aerosolizable material or that the user should look at the display 160, if present, or other light display, if present, to determine the status of the device 100.

In some examples, in response to determining a time delay or rate of change the control unit is configured to control the aerosol generator to limit or stop aerosol generation. For examples, aerosol generation may be limited or stopped when the determined time delay is less than a threshold indicating that the cartomizer 130 is depleted or nearing depletion of aerosolizable material or when the determined or rate of change is more than a threshold indicating that the cartomizer 130 is depleted or nearing depletion of aerosolizable material. Continuing to power the aerosol generator after, or close to, depletion may result in damage to the aerosol generator and/or the user experiencing an unsatisfactory puff (e.g. due to a lack of aerosol or a bad taste).

In some examples, in response to determining a time delay or rate of change the control unit is configured to control the communications interface to communicate with a separate device to update the separate device on the status of the cartomizer 130 (for example, the status may include communicating the amount of aerosolizable material remaining or a value of time delay, rate of change or capacitance).

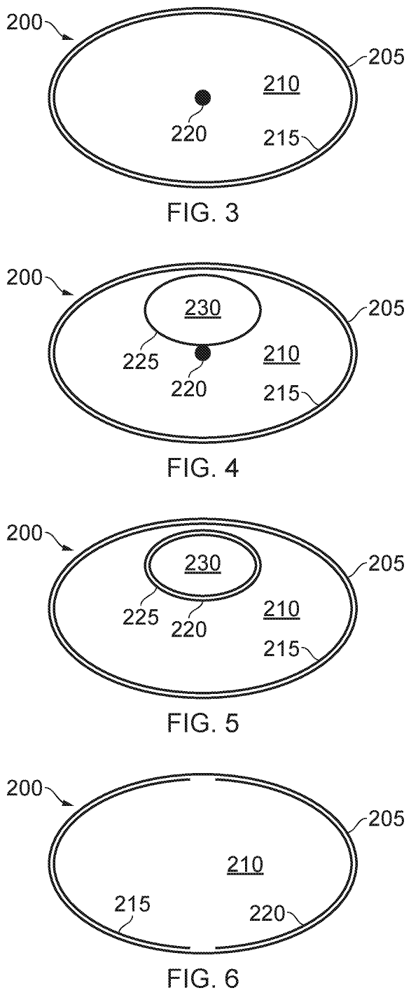

The configuration of several capacitor arrangements in accordance with the present embodiment will now be described in more detail. FIG. 3 shows a cross-sectional view through a container 200 for containing an aerosolizable material (for example, the container may be a reservoir for holding a liquid aerosolizable material). The container 200 may be formed as part of or may be provided within a cartomizer 130 in accordance with the example embodiment of FIG. 2. Alternatively, the container 200 may be a component separate from an aerosol generator. In some examples, the container 200 may be a permanent component of the body 120. Containers 200 according to the present embodiment may be refillable or may be disposable (including with any permanently attached components).

The container 200 comprises a void, cavity or space 210 within which an aerosolizable material can be provided (for example a liquid). The extent of the void 210 is defined by one or more walls including wall 205 shown in FIG. 2. The walls are configured to retain the aerosolizable material, however in some examples the wall 205 comprises apertures or openings (not shown) for receiving and/or emitting aerosolizable material, or for air flow. In some of these examples where the aerosolizable material is a liquid aerosolizable material, wicking materials may be provided that extend into one or more of these apertures and are configured to transport the aerosolizable material from the void 210.

The wall 205 of the example of FIG. 3 has an elliptical cross-sectional shape. It will be appreciated that in other examples the wall 205 may have a different cross-sectional shape, for example the wall may define a cross-sectional shape which is a polygonal shape or a rounded polygonal shape. Further, the cross-section may vary with height (perpendicular to the plane of the cross-section shown in FIG. 2); for example the cross-section may widen, narrow, and/or change shape. It will be appreciated that the composition of the wall 205 may differ depending on the aerosolizable material which it is meant to contain. However, in most examples the wall 205 will be a plastics material.

The capacitor is formed by a first electrode 215, a second electrode 220 and a dielectric between the first electrode 215 and the second electrode 220 which includes contents of the void 210 such as an aerosolizable material and/or air. The first and second electrodes are conductive materials, e.g. a metal material. In some examples, the first electrode 215 is provided adjacent the inner surface of wall 205 of container 200. In some examples the first electrode is provided on the inner surface of the wall 205 (i.e. within the void 210), while in other examples the first electrode may be embedded in the material of the wall 205 (i.e. adjacent the surface of the wall but inside the wall). In these later examples, the first electrode 215 will not interact directly with (i.e. be physically adjacent) any aerosolizable material in the void 210. Instead the dielectric will comprise part or portion of the wall 205 that is in between the first electrode and the second electrode (e.g. the portion of the wall that separates the first electrode and the second electrode). In some examples, the second electrode 220 is provided within the void 210 and physically separated from the first electrode 205.

In some examples the first electrode 215 comprises or consists of a sheet of metal (e.g. aluminum or copper). In some examples, the first electrode may be provided by coating the inner surface with a conductive material (for example by sputtering metal on to the inner surface). In some examples, the first electrode 215 may be a sheet of metal in the form of a band or strip which extends around a circumference of the wall 205. In some examples the band may have a width (or height) of greater than 5 mm, and preferably greater than 10 mm. In some examples the band has a width matching the height of the wall 205. In some examples the band may have a width matching that of an aerosolizable material provided in the void (e.g. on manufacture or to a refill limit).

In some examples, the second electrode 220 comprises a rod or sheet of metal (e.g. aluminum or copper). In some examples, the second electrode is a solid rod of material. In some examples the second electrode 220 is a rod formed from a tube made of a sheet of material. In some of these examples the tube-like rod may be provided as a hollow structure within the void 210. In others of these examples, the tube-like rod may be provided with a support structure within the rod, which may or may not be conductive. In some examples, the second electrode 220 is provided substantially centrally to the void 210. In some examples, when the second electrode 220 is a rod, the rod may have a diameter of between 0.3 mm and 4 mm, preferably between 0.5 and 2 mm, and preferably 0.5 mm. In some examples, the second electrode 220 is a planar or curved sheet of material.

In most examples the height (or width) of the second electrode 220 will be equal to the height of the first electrode 215. In some examples, the height (or width) of the second electrode 220 will not be equal to the height of the first electrode 215.

FIG. 4 shows a cross-sectional view through a container 200 for containing an aerosolizable material (for example, the container may be a reservoir for holding a liquid aerosolizable material). The container 200 may be formed as part of or may be provided within a cartomizer 130 in accordance with the example embodiment of FIG. 2. In contrast to the example container 200 of FIG. 3, the example container 200 of FIG. 4 comprises an inner wall 225 which defines an airflow channel 230 for allowing airflow through the container during a puff inhalation. Aspects of FIG. 4 which are substantially similar to those shown in FIG. 3 will not be described in detail.

In some examples the inner wall 225 is separated from the wall 205 (e.g. the outer wall 205) within the void 210. In some of these examples, the separation may be large enough to allow the aerosolizable material to surround the inner wall 225 around its whole circumference. In others of these examples, the separation may not be large enough to allow the aerosolizable material to surround the inner wall 225 around its whole circumference. In other examples the inner wall 220 and the wall 205 are connected along one or more edges or surfaces within the void 210. It will be appreciated that the inner wall 225 and wall 205 may be joined at the ends of the void (e.g. the base and ceiling) via either one or more other walls, or a convergence of the inner wall 225 and the wall 205.

The inner wall 225 of the example of FIG. 4 has an elliptical cross-sectional shape. It will be appreciated that in other examples the wall 205 may have a different cross-sectional shape, for example the wall may define a cross-sectional shape which is a polygonal shape or a rounded polygonal shape. Further, the cross-section may vary with height (perpendicular to the plane of the cross-section shown in FIG. 2); for example the cross-section may widen, narrow, and/or change shape. In some examples, the inner wall 225 has a cross-sectional shape to provide a suitable resistance-to-draw or pressure drop through the airflow channel 230 during a puff inhalation. It will be appreciated that the composition of the inner wall 225 may differ dependent on the aerosolizable material which it is meant to contain and/or the temperature of the aerosol passing through the airflow channel 230. However, in most examples the wall 205 will be a plastics material.

In the example of FIG. 4 the second electrode 220 comprises a rod or sheet of metal (e.g. aluminum or copper). In some examples the second electrode 220 is physically adjacent to the inner wall 225. In these examples the inner wall 225 may support the second electrode 220 within the void 210. In other examples the second electrode 220 is physically separated from the inner wall 225.

FIG. 5 shows a cross-sectional view through a container 200 for containing an aerosolizable material (for example, the container may be a reservoir for holding a liquid aerosolizable material). The container 200 may be formed as part of or may be provided within a cartomizer 130 in accordance with the example embodiment of FIG. 2. In contrast to the example container 200 of FIG. 4, the example container 200 of FIG. 5 comprises a second electrode 220 which extends around a circumference of the inner wall 225. Aspects of FIG. 5 which are substantially similar to those shown in FIG. 3 and FIG. 4 will not be described in detail.

In some examples, the second electrode 220 extends around a circumference of the inner wall 225 adjacent to the surface of the inner wall 225. In some examples the second electrode is provided on the inner surface of the wall 205 (i.e. within the void 210), while in other examples the second electrode 220 may be embedded in the material of the inner wall 225. In these later examples, the second electrode 220 will not interact directly (i.e. be physically adjacent) with any aerosolizable material in the void 210. Instead the dielectric will comprise part of the inner wall 225.

In some examples, the second electrode 220 is provided by coating the inner surface with a conductive material (for example by sputtering metal on to the inner surface). In some examples, the second electrode 220 is a sheet of metal in the form of a band or strip which extends around a circumference of the wall 205. In some examples the band may have a width (or height) of greater than 5 mm, and preferably greater than 10 mm. In some examples the band has a width matching the height of the wall 205. In some examples the band may have a width matching that of an aerosolizable material provided in the void (e.g. on manufacture or to a refill limit). In some embodiments the second electrode 220 has a height matching that of the first electrode 215.

In some examples, where the wall 205 and inner wall 225 are connected within the void 210, the second electrode 220 will not extend around the whole of the circumference but will instead extend around only the part of the circumference of the inner wall 225 that defines a surface of the void 210. Furthermore, where the inner wall 225 and the wall 205 join the first and second electrodes 215, 220 will not join and instead will be separated to allow the formation of the capacitor.

FIG. 6 shows a cross-sectional view through a container 200 for containing an aerosolizable material (for example, the container may be a reservoir for holding a liquid aerosolizable material). The container 200 may be formed as part of or may be provided within a cartomizer 130 in accordance with the example embodiment of FIG. 2. In contrast to the example container 200 of FIG. 3, the example container 200 of FIG. 6 comprises a first electrode 215 and a second electrode 220 which both extend around different portions of the circumference of the wall 205. Aspects of FIG. 6 which are substantially similar to those shown in FIGS. 3, 4 and 5 will not be described in detail.

In the example of FIG. 6 the first electrode 215 and the second electrode 220 both extend around a different portion of the circumference of the wall 205. In some examples the first and second electrodes 215,220 are provided on the inner surface of the wall 205 (i.e. within the void 210), while in other examples the first and second electrodes are embedded in the material of the wall 205. In these later examples, the first and second electrode 215, 220 will not interact directly (i.e. be physically adjacent) with any aerosolizable material in the void 210. Instead the dielectric will comprise part of the wall 205. The first and second electrodes 215,220 are separated by at least one gap formed by a portion of the wall 205 containing neither the first electrode 215 or the second electrode 220. In some examples the gap may be between 1 and 10 mm, and preferably between 3 and 7 mm.

In some examples the first and second electrodes 215,220 are provided on opposing portions of the wall 205. In some examples, the first and second electrodes 215,220 are symmetrically arranged with respect to a center point of the void 210. In some examples the first and second electrodes 215,220 are of a similar size. In some examples the first and second electrodes 215,220 are of substantially identical size.

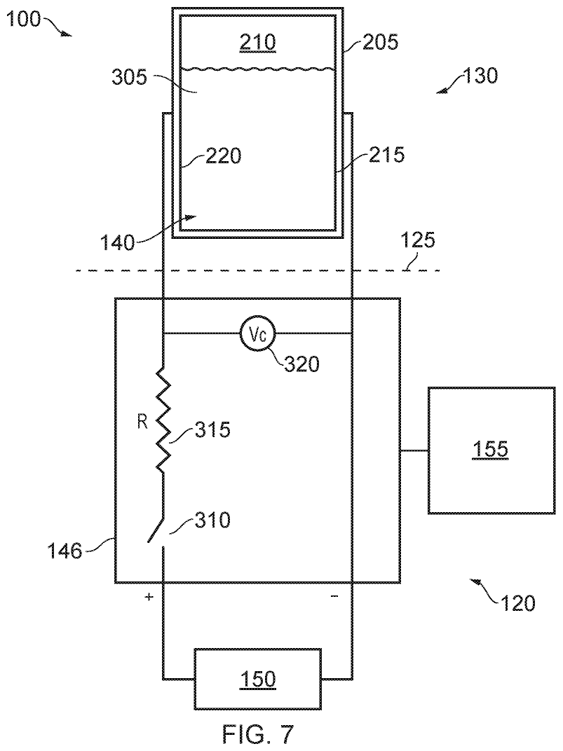

FIG. 7 is a diagram of an example sensor 146 provided within an exemplary device 100 according to one embodiment of the present disclosure. With reference to FIG. 7, the capacitor 140 may be provided in a cartridge 130 for holding an aerosolizable material (for example, the aerosolizable material may be a liquid). The cartridge 130 further comprises a connection 125 configured to provide mechanical and electrical connectivity between the body 120 and the cartridge 130. The electrical connectivity includes providing electrical connectivity between the capacitor 140 of the cartridge 130 and a sensor 146 contained within the body 120. Note that various components and details of the body 120, e.g. such as the housing, have been omitted from FIG. 7 for reasons of clarity. Aspects of FIG. 7 which are substantially similar to those shown in FIG. 2 will not be described in detail.

The example cartridge 130 of FIG. 7 broadly corresponds to the example capacitor 140 of FIG. 6. However, the example sensor 146 is not limited to use with the capacitors in accordance with the example of FIG. 6 and instead may be used with any suitable capacitor 140; for example, any of the capacitor described or depicted in relation to FIGS. 3, 4 and 5. As previously discussed the cartridge 130 comprises a first electrode 215 and a second electrode 220 provided in a void 210 defined by a wall 205. In the example shown the void 210 is partially filled with a liquid aerosolizable material 305. However, in other examples different aerosolizable materials may be used.

The example sensor 146 of FIG. 7 is provided in the body 120 and is connected electrically to a control unit 155 and a battery 150. For simplicity the example sensor 146 of FIG. 7 is shown to be separately attached to the control unit 155 and the battery 150. In some examples (not shown) power may be supplied from the battery via the control unit 155. In any examples the control unit 155 is configured to control the supply of power to the sensor 146 (e.g. either by controlling a switch 310 connecting the battery 150 to components of the sensor 146 and/or by preventing current flow to the sensor 146 through the control unit 155).

The sensor 146 comprises a resistor 315 and a voltage sensor 320. In some examples, the sensor 146 further comprises switch 310 configured to allow control of the supply of power by the control unit 155. The sensor 146, and in particular the resistor 315, forms a resistor-capacitor circuit with the capacitor 140. In some examples the resistor-capacitor circuit may be a first order resistor-capacitor circuit in that it comprises a single resistor and a single capacitor. The control unit 155 causes power to be supplied through the resistor 315 and the capacitor 140 by operating switch 310 (or by a different means if switch 310 is not provided). By supplying power, a potential difference (i.e. a voltage) is created between the electrodes of the capacitor 140. In response to the potential difference a positive charge accumulates on one electrode relative to a negative charge accumulating on the other electrode. The accumulation of charge is not instantaneous and is dependent on the resistor and the capacitor. The voltage of the capacitor (V_{c}) after time t can be calculated as

$${V}_{c} ( t ) = {V}_{s} ( 1 - {e}^{\frac{- t}{R C}} ) ,$$

where Vₛ is the voltage of supply voltage (e.g. the potential difference between the electrodes due to the connection of the battery 150), R is the resistance of the resistor 315 and C is the capacitance of the capacitor 140. V_{c} approximately equals Vₛ once

$${e}^{\frac{- t}{R C}}$$

approximately equals 0.

The capacitance C of the capacitor is proportional to the relative permittivity (i.e. dielectric constant) of the dielectric. The exact value of capacitance additionally depends on the configuration of the electrodes and their position relative to each other. In particular the capacitance depends on the distance between adjacent surfaces of the two electrodes. For example, the capacitance of a capacitor formed by two flat parallel plate electrodes is given by the equation C=ε A/d, where P is the relative permittivity, A is the area of each parallel plate and d is the distance between the parallel plates. As a further example, the capacitance of a capacitor formed by two concentric cylinders is given by the equation C=(2πε*L)/ln(R₂/R₁), where L is the length of the cylinders, R₁ is the radius of the smaller cylinder and R₂ is the radius of the larger cylinder. As such, the capacitance is directly proportional to the dielectric constant (i.e. C∝ε, or C=Xε where X is a constant). Hence, as the configuration of the electrodes is fixed (i.e. the electrodes are fixed in their respective places during manufacture), then any change in capacitance is due to a change in the dielectric between the electrodes (e.g. the aerosolizable material is vaporized and replaced by air).

When there is little or no aerosolizable material between the capacitor electrodes the dielectric constant is close to 1, whereas when there is a substantial amount of aerosolizable material between the capacitor electrodes the dielectric constant is much larger than 1 (e.g. if the aerosolizable material is a liquid the relative permittivity or dielectric constant of the liquid is likely to be in the range of 30 to 60). As a result the capacitance is smaller when there is little or no aerosolizable material between the capacitor electrodes.

In some examples, material of components other than the aerosolizable medium, such as a reservoir wall, form a part of the dielectric. Similarly to the effect of the electrode configuration, these additional components will be present independent of whether there is aerosolizable material present or not. Hence while they affect the total capacitance they will not affect the change in comparison as the aerosolizable material is used up. Rather at most they can be considered to decrease the sensitivity of the capacitor to changes in the aerosolizable material (e.g. rather than varying between 1 and 60, the dielectric constant may vary between 15 and 60). In other words the equation for capacitance can be summarized as or C=X(ε_{AM}+ε_{BG}) where ε_{AM} is the contribution to the dielectric constant of the aerosolizable material or air, and ε_{BG} is the contribution to the dielectric constant of the additional components which provide a background.

Returning to the equation

$${V}_{c} ( t ) = {V}_{s} ( 1 - {e}^{\frac{- t}{R C}} ) ,$$

when C is comparatively smaller (e.g. when there is little or no aerosolizable material) the voltage increases at a faster rate. When C is comparatively larger (e.g. when there is a substantial amount of aerosolizable material) the voltage increases at a slower rate.

The sensor 146 comprises a voltage sensor 320 configured to measure the voltage across the capacitor 140 (V_{c}), independently of the supply voltage (Vₛ). The control unit 155 retrieves readings from the voltage sensor 320. In some examples, the control unit 155 is configured to determine when V_{c} equals or exceeds a threshold voltage. In some examples, the control unit 155 is configured to determine a measurement of the time between the onset of the supply of power across the circuit and the threshold voltage being equaled or exceeded. In some examples, the control unit 155 is configured to determine a time when one or more additional threshold voltages are equaled or exceeded.

In some examples, the control unit 155 is configured to measure a time and to associate the time with measurements of the capacitor 140 (e.g. measurements of voltage, V_{c}). For example the control unit can be configured to measure the time when the capacitor voltage is zero and the time when the capacitor voltage is at the threshold. The control unit 155 can be further configured to compare the two times to determine a time delay. Alternatively, the control unit 155 may be configured to start a clock (not shown) when power is first supplied to the capacitor 140, and read the time when the capacitor voltage is at the threshold to determine the time delay.

In other examples, the control unit 155 is configured to measure a voltage after a set time from the onset of power and to compare the voltage measured when the set time has elapsed to a threshold voltage value to determine if the measured voltage is above or below threshold (thereby determining if the time delay is greater than or less than the separation between the onset time and the set time). In some examples, the control unit may be configured to measure a voltage after a set time from the onset of power and to compare the voltage to a source of comparison data (e.g. a look-up table). In some examples, the set time is a pre-determined time corresponding to the time at which V_{c} is expected to approximately equal Vₛ (i.e. within a few % of Vₛ) when there is no aerosolizable material present in the dielectric. In some examples, the control unit may be configured to measure the capacitor voltage at two times, to determine a rate of change of voltage. In some examples the control unit 155 is configured to measure times with respect to a dedicated clock (i.e. used only for capacitance measurements). In some examples the control unit 155 is configured to measure times with respect to a system clock which is used to measure a global time for the system. In comparison, a dedicated clock may be reset for each measurement (i.e. so that 0V corresponds to 0 μs at the beginning of a measurement), while the system clock measures time independently of the capacitance measurements.

In the absence of a supply voltage (i.e. when the supply voltage is 0V), the capacitor 140 will discharge until the voltage of the capacitor 140 (between the two electrodes) reaches 0V. The discharge rate with respect to time is the inverse of the charge rate with respect to time. In some examples, the control unit 155 can be configured to measure voltages at one or more times during the discharge. In some examples, the control unit 155 is configured to compare a measured voltage (or multiple measured voltages) with a second threshold voltage value. In some examples, the control unit 155 is configured to calculate a rate of change of voltage based on two or more measurements of voltage during the discharge of the capacitor (where one of the measurements may be a measurement taken when the supply voltage is switched out of the circuit). In some examples, the measured voltages are compared with a source of comparison data (e.g. a look-up table). For these examples, the capacitor 140 is first charged such that V_{c} approximately equals Vₛ. This can be achieved by either supplying power until the measured voltage approximately equals Vₛ, or by supplying power for a pre-determined time corresponding to the time at which V_{c} is expected to approximately equal Vₛ (i.e. within a few % of Vₛ) when there is the maximum amount of aerosolizable material present in the dielectric. In some examples measurements of voltage during discharge of the capacitor are used in conjunction with measurements of voltage during charge of the capacitor to improve the reliability of the sensor 146.

In some examples, the control unit 155 samples the sensor 146 with a fixed sampling rate (e.g. 10 MHz). In some embodiments, the fixed sampling rate is 10 MHz or greater, preferably 15 MHz or greater, more preferably greater than 20 MHz. An upper limit of 100 MHz can be imposed from the view point of ensuring the cost and size of the system is viable. In some of these examples the control unit 155 is configured to measure time based on the number of sampled measurements between two measurements of interest (e.g. a measurement marking the onset of power and a measurement marking the threshold being reached or surpassed). In some of these examples the control unit 155 is configured to convert the number of sampled measurements into a measure of time in accordance with SI units.

The threshold voltage is generally less than the supply voltage. In some examples, the threshold voltage may be in the range selected from one or more ranges in the group comprising 80-90% of the supply voltage, 70-80% of the supply voltage, 60-70% of the supply voltage, 50-60% of the supply voltage, 40-50% of the supply voltage, 30-40% of the supply voltage, 20-30% of the supply voltage, and 10-20% of the supply voltage. In some examples, the threshold voltage may be a voltage in the range selected from the group comprising between 0.1V to 5V, 0.5V to 3V, 1.0V to 2.8V, 1.5V to 2.6V, and 2.0V to 2.5V. In some examples, the supply voltage may be a voltage in the range selected from the group comprising between 1.0V to 6.5V, 2.0V to 4.5V, 2.3V to 3.5V, and 2.5V to 3.0V. In some examples, the threshold voltage may be an absolute value defined with respect to the supply voltage. For example, the threshold voltage may be a voltage in the range selected from the group comprising the supply voltage minus a voltage of between 0.2 and 1.5 volts, and the supply voltage minus a voltage of between 0.5 and 1.0 volts.

The supply voltage may be different to the voltage available from the battery. In particular a regulator may be used to regulate the voltage from the battery such that the supply voltage is greater or lower than the battery voltage. For example a DC-DC convertor can be used to step-up or step down the battery voltage. It can be advantageous for the supply voltage to be a relatively high voltage so that the resolution of the measurement is increased.

The time delay (or conversely the rate of change) between power being supplied to the capacitor 140 and the sensor 146 measuring a voltage equaling or exceeding a voltage threshold is dependent on the resistance of the resistor 315. By increasing the resistance of the resistor 315, the time delay between power being supplied to the capacitor 140 and the sensor 146 measuring a voltage equaling or exceeding a voltage threshold can be increased. An appropriate resistor 315 can be selected to provide a time delay measurable by the control unit 155 in conjunction with the sensor 146. It will be appreciated that the appropriate choice of resistor 315 depends on at least the configuration of the capacitor (e.g. its resulting capacitance) and the time scales that are measurable by the control unit 155 in conjunction with the sensor 146. In some examples, the resistor 315 may have a resistance in the range selected from the group comprising 50 to 1000 kΩ, 100 to 800 kΩ, 150 to 600 kΩ, and 200 to 400 kΩ.

The time delay (or conversely the rate of change) between power being supplied to the capacitor 140 and the sensor 146 measuring a voltage equaling or exceeding a voltage threshold is dependent on the capacitance of the capacitor 140 which, as previously stated, is dependent on the configuration of the two electrodes (e.g. dependent on their separation and their adjacent surface area) and the dielectric constant of the material between the two electrodes. As such, if the dielectric between the two electrodes changes (e.g. the amount of liquid aerosolizable material 305 between the two electrodes drops) then the dielectric constant will change and as a result so will the capacitance of the capacitor 140 and the time delay. The capacitance can, broadly speaking, be increased by increasing the surface area of each of the electrodes and such that the electrodes have a greater surface area adjacent to one another. In some examples, the capacitor 140 is configured to have a capacitance in the range selected from the group comprising 0.1 to 100 pF, 0.5 pF to 70 pF, and 1.0 pF to 60 pF when empty or filled with aerosolizable material. Capacitances of less than these value ranges require increasingly sensitive components to perform the measurement accurately and/or larger resistance resistors, both of which increase the cost of the device.

The configuration of the electrodes of FIG. 7 surrounds the void 210 within which the liquid aerosolizable material 305 is provided, such that a change in liquid volume results in a change in the amount of liquid material in the dielectric. As a result the time delay, rate of change and/or the capacitance is indicative of an amount of liquid aerosolizable material 305 in the cartomizer 130. In some examples, the device 100 is configured to comprise a resistor 315 and capacitor 140 (i.e. the resistor-capacitor circuit) configured to provide a time delay between the onset of the supply of power to the capacitor and the capacitor reaching a threshold voltage of between 1 and 200 μs, preferably between 2 and 100 μs, more preferably between 2 and 50 μs, and preferably between 5 and 20 μs. Resistor-capacitor circuits providing a time delay within these ranges have been found to provide a sufficiently prompt and accurate response without the need for expensive and/or bulky components. For example, as explained above, control units 155 can be configured to sample at rates of around 10 MHz and therefore within a period of between 2 and 50 μs there are between 2 and 50 measurements.

As explained above, the sensor 146 is not limited to being able to measure voltage across the capacitor, but may also be able to determine other electrical characteristics, such as charge or current. In the context of the sensor 146 determining charge, it is to be noted that Q (charge)=V (voltage)×C (capacitance). Thus, the charge on the capacitor will vary based on the capacitance which, as explained above, will vary based on the dielectric (the amount of aerosolizable material present). Thus, by measuring the charge Q at the capacitor at a first time relating to the onset of power to the capacitor, and comparing it to a charge at a second time, it is possible to determine an amount of aerosolizable material present.

In some examples, the capacitor may be discharged before a threshold electrical characteristic is determined. This will ensure that any first determined electrical characteristic has not been determined in light of a previous state of the capacitor. This can be done by simply ensuring that, at an appropriate time, the voltage input of the RC circuit is connected to ground.

The present disclosure will now be further described with reference to the following non-limiting examples.

### Examples

A number of aerosol delivery systems comprising electronic aerosol provision devices and cartridges were used to assess the change in capacitance between cartridges which were fully filled and cartridges which were empty or nearly empty of a liquid aerosolizable material (e.g. an e-liquid).

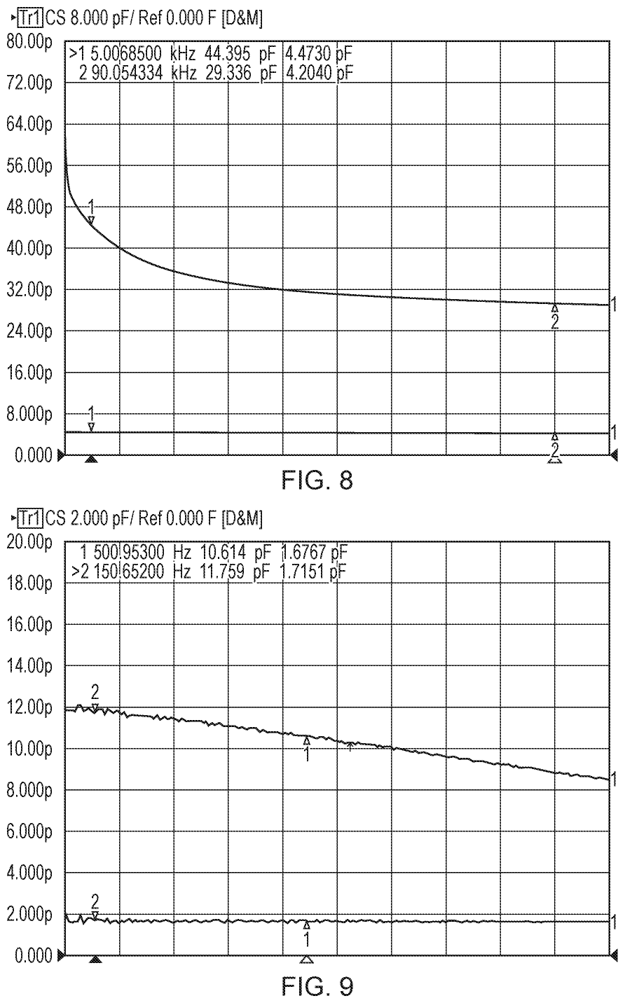

FIG. 8 shows a graph of capacitance measurement against AC frequency for a device have a cartridge broadly in accordance with the example cartridge of FIG. 3. The cartridge measured for the graph of FIG. 8 comprised a cylindrical cartridge having a copper sheet around an outer wall and a steel rod within the cartridge thereby forming a cylindrical capacitor. The capacitance of the cartridge when full (top line) and when empty (bottom line) was measured by applying an alternating current to the capacitor using an E4990A impedance analyzer. The capacitance measured depends upon the frequency of the alternating current due to the frequency dependence of the permittivity of the dielectric material of the capacitor, although such a frequency dependence of air is almost zero. For each measurement the frequency of the alternating current was changed over a frequency band and as a result the measured capacitance also changed. FIG. 8 shows that the capacitance is higher when the cartridge is full and that the capacitance is lower when the cartridge is empty. Furthermore FIG. 8 shows that the difference in capacitance between a full and empty cartridge is enhanced by the use of lower frequencies (e.g. <500 Hz). For example, at the location marked “1” the frequency is 5 kHz and the capacitance increased from about 4.5 pF, when there was no liquid present, to 44.4 pF, when there was liquid present. This is an increase of around 10 times. In contrast, at the location marked “2” the frequency is 90 kHz and the capacitance increased from about 4.2 pF, when there was no liquid present, to 29.3 pF when there was liquid present. This is an increase of around 7 times. The projected measurement result at DC is more than 60 pF when there was liquid present while remaining at 4.5 pF when there was no liquid present. This is an increase of more than 13 times. Therefore, it is easier and more accurate to perform a capacitance measurement at DC.

FIG. 9 shows a graph of capacitance measurement against AC frequency for a device have a cartridge broadly in accordance with the example cartridge of FIG. 4. The cartridge measured for the graph of FIG. 9 comprised a cartridge having a copper sheet around an outer wall and a copper rod within the cartridge adjacent an inner airflow channel to form a cylindrical capacitor. The capacitance of the cartridge when full (top line) and when empty (bottom line) was measured by applying an alternating current to the capacitor using an E4990A impedance analyzer.

The capacitance measured depends upon the frequency of the alternating current due to the frequency dependence of the permittivity of the dielectric material of the capacitor. For each measurement the frequency of the alternating current was changed over a frequency band and as a result the measured capacitance also changed. FIG. 9 shows that the capacitance is higher when the cartridge is full and that the capacitance is lower when the cartridge is empty. Furthermore, FIG. 9 shows that the difference in capacitance between a full and empty cartridge is enhanced slightly by the use of lower frequencies (e.g. <150 Hz). For example, at the location marked “2” the frequency is 150 Hz and the capacitance increased from about 1.7 pF, when there was no liquid present, to 11.8 pF when there was liquid present. This is an increase of around 7 times. In contrast, at the location marked “1” the frequency is 500 Hz and the capacitance increases from about 1.7 pF, when there was no liquid present, to 10.6 pF, when there was liquid present. This is an increase of around 6 times. The projected measurement result at DC is more than 12 pF when there was liquid present while remaining at 1.7 pF when there was no liquid present. This is an increase of more than 7 times. Therefore, it is easier and more accurate to perform a capacitance measurement at DC.

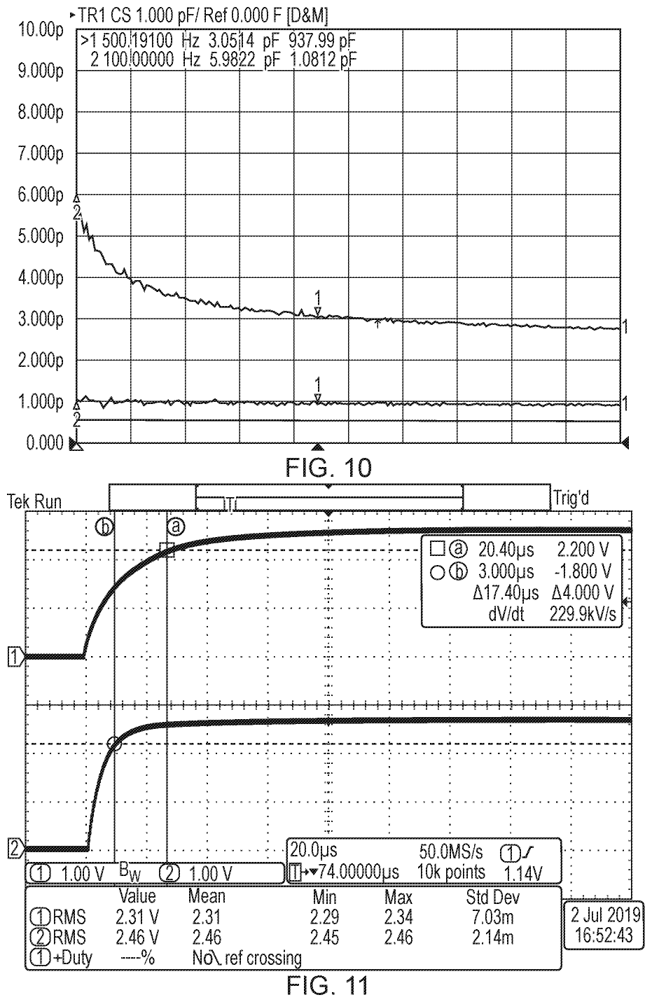

FIG. 10 shows a graph of capacitance measurement against AC frequency for a device have a cartridge broadly in accordance with the example cartridge of FIG. 6. The cartridge measured for the graph of FIG. 10 comprised a cartridge having two copper sheets provided on each side of the cartridge and separated by a small gap at each joint to form a cylindrical capacitor. The capacitance of the cartridge when full (top line) and when empty (bottom line) was measured by applying an alternating current to the capacitor using an E4990A impedance analyzer. The capacitance measured depends upon the frequency of the alternating current due to the frequency dependence of the permittivity of the dielectric material of the capacitor. For each measurement the frequency of the alternating current was changed over a frequency band and as a result the measured capacitance also changed. FIG. 10 shows that the capacitance is higher when the cartridge is full and that the capacitance is lower when the cartridge is empty. Furthermore, FIG. 10 shows that the difference in capacitance between a full and empty cartridge is enhanced by the use of lower frequencies (e.g. <150 Hz). For example, at the location marked “2” the frequency is 100 Hz and the capacitance increased from about 1.1 pF, when there was no liquid present, to 6.0 pF when there was liquid present. This is an increase of around 5 times. In contrast, at the location marked “2” the frequency is 500 Hz and the capacitance increases from about 0.9 pF, when there was no liquid present, to 3.0 pF, when there was liquid present. This is an increase of around 3 times. The projected measurement result at DC is more than 6 pF when there was liquid present while remaining at 1.1 pF when there was no liquid present. This is an increase of more than 5.5 times. Therefore, it is easier and more accurate to perform a capacitance measurement at DC. To perform capacitance measurement at DC, we consider that using a DC current to measure a time delay between a first and second voltage or the rate of change in voltage provides a more feasible indication of the capacitance of the cartridge particular where cost and size of components has to be considered.

FIG. 11 shows a graph of a voltage against time for a device have a cartridge broadly in accordance with the example cartridge of FIG. 3. The measurements shown depict a capacitor voltage rising time when a 2.7 V DC voltage is applied to a resistor-capacitor circuit for a cartridge filled with e-liquid (trace “1”) and a 10 pF capacitor simulating a nearly empty cartomizer (trace “2”). The resistor-capacitor circuit for both trace “1” and trace “2” comprises a 270 kΩ resistor. Traces “1” and “2” have been offset from the origin of the y-axis (0V) by arbitrary amounts (trace “1” is offset by +1V and trace “2” is offset by −3V) in order to present both traces clearly in the same display window. The intersections “a” and “b” mark a respective voltage threshold of 2.2V with respect to the starting voltages (+1V and −3V respectively).

For trace “1”, the time delay between the applying power to the capacitor and the capacitor reaching a voltage of 2.2V was approximately 26.4 μs. For trace “2”, the time delay between applying power to the capacitor and the capacitor reaching a voltage of 2.2V was approximately 9 μs. Therefore the time delay associated with an empty cartridge was approximately 17.4 μs shorter than the time delay associated with a full cartridge.

As an example of alternative calculations to determine whether the cartridge of FIG. 11 is empty or full, the rate of change could be measured. For trace “1” a rate of change in capacitance can be calculated as 2.2V divided by 26.4 μs which equals 0.08 V/μs. For trace “2” a rate of change in capacitance can be calculated as 2.2V divided by 9 μs which equals 0.24 V/μs.

As a further example of an alternate calculation to determine whether the cartridge of FIG. 11 is empty or full, a control unit could be configured to determine if a cartridge is empty by measuring voltage at a set time after the onset of the application of power to the capacitor (e.g. ˜10 μs), and to compare the measured voltage with a threshold (e.g. 2.1V). If the measured voltage is higher (the time delay is shorter than 10 μs) the cartridge is empty, and if the measured voltage is lower (the time delay is longer than 10 μs) the cartridge is not empty.

As a further example of an alternate calculation to determine the amount of aerosolizable material in a cartridge in accordance with FIG. 11, a control unit could be configured to determine the amount of aerosolizable material in a cartridge by measuring voltage at a set time after the onset of the application of power to the capacitor (e.g. ˜10 μs), and to compare the measured voltage with a source of comparison data. In some examples, the set time is a pre-determined time corresponding to the time at which V_{c} is expected to approximately equal Vₛ (i.e. within a few % of Vₛ) when there is no aerosolizable material present in the dielectric. The source of comparison data can indicate the amount of aerosolizable material present in the dielectric corresponding to a particular measured voltage at the set time. The comparison data can be created empirically for each cartridge and aerosolizable material type.

Hence with a suitably configured control unit 155 and cartomizer sensor 146 it is feasible to measure and determine a difference between an empty and a filled cartridge. For example based on the experimental system used for FIG. 11 above, a control unit configured to sample at greater than 10 MHz would be able to identify a change. For example, such a control unit would take a sample every 0.1 μs and therefore would be able to distinguish between the threshold voltage being by the first measurement for “empty” and by the third measurement for “full”. By increasing the sampling rate greater accuracy can be achieved which may allow for a more accurate measurement of the amount of aerosolizable material. Furthermore, in some cases different cartridges may require more greater sampling rates to provide the necessary accuracy to distinguish between “empty” and “full” states. As previously discussed, by increasing the resistor and/or by modifying the capacitor the time delay can be increased and the required sampling rate can be reduced.

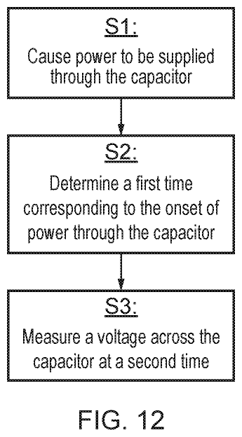

FIG. 12 schematically represents a method of controlling an aspect of the electronic aerosol provision device in accordance with certain embodiments of the disclosure. The device comprises a cartridge comprises a capacitor formed by a first electrode, a second electrode and a dielectric between the first electrode and second electrode, a sensor for measuring the capacitance of the capacitor, and a control unit, wherein the dielectric comprises an aerosolizable material and/or air provided in a cavity between the first electrode and the second electrode. The method comprises the control unit causing power to be supplied through the capacitor (S1); determining a first time corresponding to the onset of power through the capacitor (S2); and measuring a voltage across the capacitor at a second time (S3).

In some examples the second time is the time at which the measured voltage equals or exceeds a threshold voltage and a comparison is performed based on the elapsed time between the first time and the second time. The control unit may be configured in these examples to sample at regular intervals. In these examples the method further comprises determining a comparison value as the difference between the first time and the second time (e.g. a value of the time delay is determined to be the time between the first time and the second time) (S4A), and comparing the comparison value (i.e. the value of time delay) to a threshold (S5A), wherein the threshold is a threshold time delay.

In some examples a comparison is performed based on a rate of change of the voltage between the first time and the second time. In these examples the method further comprises determining a comparison value based at least on the measured voltage (S4B), wherein the comparison value is a rate of change of the voltage (e.g. between the first time and the second time), and comparing the comparison value (i.e. the value describing the rate of change of the voltage between the first time and second time) to a threshold (S5B). In some examples, the second time may be a predetermined amount of time after the first time. In some examples, the second time may be an arbitrary time corresponding to a voltage measurement from which a rate can be established with sufficient accuracy.

In some examples a comparison is performed based on the voltage measured across the capacitor at the second time (S3). In these examples the method further comprises comparing the comparison value (i.e. the measured voltage) to a threshold (S4C), wherein the threshold is a threshold voltage. In some examples, the second time may be a predetermined amount of time after the first time.

In some examples, the control unit is further configured to control an aspect of the electronic aerosol provision device based on the comparison of the comparison value to the threshold, wherein the aspect is any one selected from the group comprising one or more light emitting unit, a display, a haptic module, a speaker and a wired or wireless communications interface.

Thus there has been described a method of controlling an aerosol provision system comprising a capacitor formed by a first electrode, a second electrode and a dielectric between the first electrode and second electrode, a sensor for sensing the voltage across the capacitor, and a control unit, wherein at least a portion of the dielectric is provided in a cavity between the first electrode and the second electrode, the method comprises the control unit: causing power to be supplied through the capacitor, determining a first time corresponding to the onset of power through the capacitor, and measuring a voltage across the capacitor at a second time.

Thus there has also been described an aerosol provision system comprising a capacitor formed by a first electrode, a second electrode and a dielectric between the first electrode and second electrode, wherein at least a portion of the dielectric is provided in a cavity between the first electrode and the second electrode, a sensor for sensing voltage across the capacitor, and a control unit configured to cause power to be supplied through the capacitor, determine a first time corresponding to the onset of power through the capacitor, and measure a voltage across the capacitor at a second time.

Thus there has also been described aerosol provision means comprising capacitor means formed by a first electrode, a second electrode and dielectric means between the first electrode and second electrode, wherein at least a portion of the dielectric means is provided in a cavity between the first electrode and the second electrode, sensor means for sensing voltage across the capacitor means, and control means configured to cause power to be supplied through the capacitor means, determine a first time corresponding to the onset of power through the capacitor means, and measure a voltage across the capacitor means at a second time.

In order to address various issues and advance the art, this disclosure shows by way of illustration various embodiments in which that which is claimed may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A method of controlling an electronic aerosol provision system comprising a capacitor formed by a first electrode, a second electrode and a dielectric between the first electrode and the second electrode, a sensor for sensing an electrical characteristic of the capacitor, and a control unit, wherein at least a portion of the dielectric is provided in a cavity between the first electrode and the second electrode, the method comprising:
causing power to be supplied to the capacitor;
identifying an onset of the power to the capacitor at a first time; and
measuring an electrical characteristic of the capacitor at a second time.

2. The method of claim 1, wherein the method is for determining an amount of aerosolizable material between the first electrode and the second electrode.

3. The method of claim 2, wherein the control unit is configured to control an aspect of the electronic aerosol provision system based on the determined amount of aerosolizable material between the first electrode and the second electrode, wherein the aspect is any one selected from the group consisting of: an aerosol generator, one or more light emitting units, a display, a haptic module, a speaker, and a wired or wireless communications interface.

4. The method of claim 1, wherein the method further comprises, by the control unit:
determining a comparison value based at least on the measured electrical characteristic, wherein the comparison value is a rate of change of the electrical characteristic; and
comparing the comparison value to a threshold, wherein the threshold is a rate of change.

5. The method of claim 1, wherein the second time is a time at which the measured electrical characteristic equals or exceeds a threshold electrical characteristic; wherein the method further comprises, by the control unit:
determining a comparison value as a difference between the first time and the second time; and
comparing the comparison value to a threshold, wherein the threshold is a period of time.

6. The method of claim 1, wherein the second time is a set amount of time after the first time and the measured electrical characteristic is a comparison value, wherein the method further comprises, by the control unit:
comparing the comparison value to a threshold, wherein the threshold is a threshold electrical characteristic.

7. The method of claim 1, wherein the electrical characteristic is selected from one or more of voltage, current, and charge.

8. The method of claim 7, wherein the electrical characteristic is a voltage across the capacitor.

9. The method of claim 8, wherein the threshold electrical characteristic is a voltage in a range selected from the group consisting of: 0.5V to 3V, 1.0V to 2.8V, 1.5V to 2.6V, and 2.0V to 2.5V.

10. The method of claim 7, wherein, when power is supplied to the capacitor, a supply voltage is applied between the first electrode and the second electrode, wherein the threshold electrical characteristic is a voltage in a range selected from the group consisting of: the supply voltage minus a voltage of between 0.2 and 1.5 volts, and the supply voltage minus a voltage of between 0.5 and 1.0 volts.

11. The method of claim 1, wherein the capacitor has a capacitance in a range selected from the group consisting of: 0.1 to 100 pF, 0.5 pF to 70 pF, and 1.0 pF to 60 pF.

12. The method of claim 1, wherein the sensor comprises a resistor configured to form a resistor-capacitor circuit with the capacitor.

13. The method of claim 12, wherein the resistor has a resistance in a range selected from the group consisting of: 50 to 1000 kΩ, 100 to 800 kΩ, 150 to 600 kΩ, and 200 to 400 kΩ.

14. The method of claim 12, wherein the resistor-capacitor circuit is configured to provide a time delay between the onset of the supply of power to the capacitor and the capacitor reaching a threshold electrical characteristic, the time delay selected from the group consisting of: between 2 and 50 μs, and between 5 and 30 μs.

15. The method of claim 1, wherein the sensor comprises a switch and the control unit is configured to control the switch to cause power to be supplied through the capacitor.

16. The method of claim 4, wherein the threshold is a pre-determined value.

17. The method of claim 4, wherein the threshold is based on a first measurement of the capacitor by the sensor.

18. The method of claim 17, wherein the first measurement is performed when one or more of the following is determined by the control unit:
the electronic aerosol provision device is first turned on;
a first time the control unit determines the capacitor is present after a period in which the capacitor was determined not present; or
a first time the control unit determines aerosolizable material is present after a period in which aerosolizable material was determined to not be present.

19. The method of claim 4, wherein the control unit is configured to determine a capacitance of the capacitor based on at least the comparison value.

20. The method of claim 4, wherein the control unit is configured to determine an amount of aerosolizable material based on at least the comparison value.

21. The method of claim 1, wherein one or both of the first electrode and the second electrode are provided adjacent a surface of a wall defining the cavity.

22. The method of claim 21, wherein one or both of the first electrode and the second electrode are embedded in the wall, wherein the dielectric comprises any portion of the wall separating the first electrode and the second electrode.

23. The method of claim 21, wherein the first electrode is provided adjacent the surface and the second electrode is provided within the cavity and substantially separated from the wall.

24. The method of claim 21, wherein the first electrode is provided adjacent the surface and the second electrode is provided adjacent the surface of an inner wall defining an airflow channel passing through the cavity.

25. The method of claim 1 any of claims 1 to 24, wherein the aerosolizable material comprises a liquid aerosolizable material.

26. An electronic aerosol provision system comprising:
a capacitor formed by a first electrode, a second electrode, and a dielectric between the first electrode and the second electrode, wherein at least a portion of the dielectric is provided in a cavity between the first electrode and the second electrode;
a sensor for sensing an electrical characteristic of the capacitor; and
a control unit configured to cause power to be supplied to the capacitor and to identify an onset of power to the capacitor at a first time, and determine from the sensor an electrical characteristic of the capacitor at a second time.

27. The electronic aerosol provision system according to claim 26, wherein the electronic aerosol provision system comprises a device that comprises the capacitor.

28. The electronic aerosol provision system according to claim 26, wherein the electronic aerosol provision system comprises a cartridge comprising the capacitor, and a device configured to attach to the cartridge.

29. A cartridge for use with the device of claim 28, wherein the cartridge comprises:
the capacitor formed by the first electrode, the second electrode, and the dielectric between the first electrode and the second electrode, wherein the dielectric comprises at least one of an aerosolizable material or air provided in a cavity between the first electrode and the second electrode, and wherein the cartridge is configured to attach to the device.

30. The cartridge of claim 29, wherein the cartridge comprises a heater configured to selectively aerosolize the aerosolizable material to generate the inhalable medium.

31. The cartridge of claim 29, wherein the cartridge comprises a memory and wherein the control unit is configured for at least one of: reading the memory to obtain the threshold, or writing to the memory.

32. Electronic aerosol provision means comprising:
capacitor means formed by a first electrode, a second electrode, and dielectric means between the first electrode and the second electrode, wherein at least a portion of the dielectric means is provided in a cavity between the first electrode and the second electrode;
sensor means for sensing an electrical characteristic of the capacitor means; and
control means configured to cause power to be supplied to the capacitor means and to identify an onset of power to the capacitor at a first time, and determine from the sensor means an electrical characteristic of the capacitor means at a second time.
